(19) United States
(12) Patent Application Publication
(10) Pub. No.: US 2002/0048372 A1
(43) Pub. Date: Apr. 25, 2002

(54) Universal signature object for digital data

(76) Inventors: Eng-Whatt Toh, Singapore (SG); Kok-Khuan Fong, Singapore (SG); Raj Maharjan Madhav, Singapore (SG); Kok-Hoon Teo, Singapore (SG)

Correspondence Address: FENWICK & WEST LLP, TWO PALO ALTO SQUARE, PALO ALTO, CA, 94306, US

(21) Appl. No.: 09/981,588

(22) Filed: Oct. 16, 2001

Related U.S. Application Data
(60) Provisional application No. 60/242,113, filed on Oct. 19, 2000.
(60) Provisional application No. 60/242,013, filed on Oct. 19, 2000.

(51) Int. Cl. H04L 9/00

(52) U.S. Cl. 380/285; 713/180

(57) ABSTRACT

Systems, methods and computer-readable media for generating and utilizing a universal signature object (100). A universal signature object (100) binds a digital signature (112) to digital data (200), regardless of the file format of the version of the digital data (200). A signing program (400) generates a universal signature object (100) or appends a digital signature (122) to a previously generated universal signature object (100). A universal-signature-object viewer (600) utilizes a universal signature object (100) to display information contained in the universal signature object (100) or generated from the universal signature object (100).

### RELATED APPLICATIONS

This application claims priority under 35 U.S.C. § 119(e) to commonly-assigned U.S. Provisional Patent Application Serial No. 60/242,113, “Universal Object For E-Signed Digital Contents,” by Eng-Whatt Toh, filed Oct. 19, 2000; and commonly-assigned U.S. Provisional Patent Application Serial No. 60/242,013, “Efficient Method For Routing Deliveries Through Recipient Translation,” by Eng-Whatt Toh, filed Oct. 19, 2000. The subject matters of the foregoing applications are incorporated herein by reference in their entirety.

### BACKGROUND OF THE INVENTION

1. Field of the Invention

The present invention relates generally to digital signatures. More particularly, the invention relates to computer-implemented systems and techniques for binding a digital signature to digital data regardless of the file format of the digital data, and for utilizing the same.

2. Description of Background Art

With the increased use of computers, a great many items both in business and in people's personal lives exist, at some point, in digital form. These items include business documents, digital audio, digital video, pamphlets, presentations, digital graphics, and even computer applications and programs. Technology now exists to transact and trade entirely in digital form. Since items can readily be exchanged digitally, the need for physical copies has been lessened. Furthermore, law-making entities of different countries have legitimized digital signatures as being equivalent to traditional, or wet, signatures. With these laws, it is now possible for people and businesses to transact by exchanging electronic documents and applying their digital signatures without ever using hard copies.

Electronic signature technologies are based on cryptography. Cryptographic algorithms can generally be divided into two classes: symmetric key cryptography and asymmetric key cryptography. Of the two types, asymmetric key cryptography is used to generate digital signatures.

Asymmetric key encryption, also called public-key encryption, involves a pair of keys—a public key and a private key. The keys themselves are typically large numbers derived from complex mathematical algorithms. These keys are used to encrypt and/or decrypt digital data. Once a user has a key pair, the user typically keeps the private key secret but publishes the corresponding public key. The public key and the private key are mathematically related so that one key can decrypt data encrypted by the other key. However, the mathematical relationship between the keys is sufficiently complex that it is computationally infeasible to derive one key given the other.

One application of public-key encryption is secure data delivery. Thus, if a sender wants to send data to a recipient in a manner such that only the recipient can read the data, the sender can encrypt the data with the recipient's public key. Since only the recipient's private key can decrypt the data, the sender can be assured that only the recipient can read the data, assuming that the recipient is the only one with access to the private key.

In addition to encrypting data so that only specific individuals can decrypt the data, public-key encryption can also be used for digital signatures. For example, public-key encryption allows the recipient of digitally signed data to verify the identity of the signatory. Assuming that the data is encrypted using the signatory's private key, it can be decrypted only by the corresponding public key. If a recipient can decrypt data using the signatory's public key, he can be assured that the data was originally encrypted using the corresponding private key. Thus, the recipient can be assured that the signatory was the one who encrypted the data. In other words, the signatory has digitally signed the data.

However, for this identification to be effective, the recipient must receive the signatory's public key in a manner in which the recipient trusts that the key is in fact the signatory's public key and not someone else's public key. This trusted transmission of the signatory's public key can occur in several ways. For example, the signatory could personally give the public key to the recipient. Alternatively, the signatory could deliver the public key via a trusted delivery service.

Another possible method is to link the signatory to his public key by a digital certificate issued by a trusted third party. A digital certificate is a digital document that identifies a certain public key as belonging to, or is associated with, a certain entity, such as an individual, a legal entity, a Web server, or the like, in a trustworthy manner. A trusted third party, known as a certificate authority (“CA”), typically issues a digital certificate. The CA issues a certificate that identifies, among other things, an entity and that entity's public key. In this manner, the CA acts like a notary, attesting that a certain key belongs to a certain entity. A recipient who trusts the CA can be assured that any data decrypted with that public key must have been encrypted with the corresponding private key, and if only the signatory has access to that private key, the recipient knows that the signatory encrypted the data.

A digital signature may be generated in other ways as well. For example, instead of digitally signing the data, the signatory can digitally sign a hash or digest of the data. A hash or digest is obtained by operating a hash algorithm on the data file. A hash algorithm is a method of transforming a variable length message, in this case the data file, into a fixed length number. This fixed length number is referred to as the hash or digest of the original data file. For this digest to be useful as part of a digital signature, the contents of the data file must not be practically ascertainable from the digest number. Thus, hash algorithms are one-way functions, which can easily generate a hash from a data file, but which cannot, for all practical purposes, generate the original data file given the hash. The digest's usefulness as a digital fingerprint of a data file also depends upon its ability to correlate uniquely to the original data file. Ideally, a hash algorithm is a strictly one-to-one function so that each hash number can be generated by one, and only one, data file. Any change in the data file, no matter how insignificant, will generate a different hash number. If a hash algorithm generates the same hash for two different data files, a collision exists which could compromise the usefulness of the hash. Thus, one measure of a hash algorithm's usefulness is the frequency at which more than one data file will generate the same hash number. In practice, useful hash algorithms may generate collisions in theory but the probability is low enough as to be practically negligible. Well-known one-way hash algorithms that are useful for digital signing include MD2, MD5, and SHA-1.

The hash of the data file, along with information about the hash algorithm used to generate the hash, is then encrypted with the signatory's private key. The signatory provides the original data file as well as the encrypted hash to the recipient. The recipient uses the signatory's public key to decrypt the hash. To verify the integrity of data, the recipient uses the same hash algorithm on the original data file. If the hash generated by the recipient does not match the decrypted hash, this indicates a problem. The digital signature may not have been created with the signatory's private key or the data may have been tampered with since the signatory signed it. If the hashes match, the recipient can be reasonably assured that the signatory signed the data and that it has not been altered. For the following discussion of the present invention, references to digital signatures or digitally signing shall include all of the aforementioned variants of the digital signatures and digitally signing.

Although the technology exists to create digital signatures, there are several challenges for a practical digital signature system. For example, because personal and business users work with various applications and with various types of documents, each of which may require a signature or signatures, a universal solution requires support for digital signing of any digital data, regardless of the file format. Also, many transactions, particularly business transactions, require support for multiple signatures and easy exchange of files and digital signatures. Furthermore, users require effective archiving that binds a digital signature or digital signatures with the signed digital data.

Current technology allows a digital signature to be generated for digital files, but there does not exist a universal object that will bind digital signatures to digital data, regardless of the file format. For example, word processor plug-ins are available which allow documents in Microsoft Word format to be digitally signed, but such functionality is not available for all applications and file formats. In addition, other digital signature services store signatures online but do not bind them to the original content for archiving. Nor do these services easily support countersigning.

What is needed is a universal signature object that can bind digital signatures to digital data, regardless of the file format. With such an object, people and businesses could more easily exchange documents and countersign data, such as contracts, without reverting to hard copies. Furthermore, with such an object, the digital data and all digital signatures can easily be archived.

### SUMMARY OF THE INVENTION

In accordance with the present invention, there is provided a universal signature object (100) for binding digital data (200) to at least one digital signature (112). In an embodiment, the universal signature object (100) contains a version (102, 103, or 104) of the digital data (200), information (106) concerning an application compatible with a file format of at least one of the versions (102, 103, 104), and signature information (108) of at least one signatory. The signature information (108) of a signatory contains at least one digital signature (112) of signature data (570), which is functionally related to the digital data (200).

In one variant, the signatory information (110) also contains timestamp information (116). In another embodiment, the signature information (110) contains information about the signatory's public key (118). In yet another embodiment, the universal signature object (100) includes use-permission information (130) indicating how a version or versions of the digital data (200) can be utilized. Alternatively, the universal signature object (100) includes a universal-signature-object viewer (600) for utilizing the universal signature object (100) to generate and display information from or related to the universal signature object (100). In an embodiment, the universal signature object (100) includes a signing program (400), which is an executable file used to generate a universal signature object (100) or to append a digital signature to an existing universal signature object (100).

In another aspect of the invention, a universal-signature-object viewer (600) includes an application launching means (602) and a viewer means (604). The application launching means (602) launches an application compatible with a file format of a version of the digital data (200). The viewer means (604) generates information concerning the universal signature object (100) for display to a user of a USO viewer (600). In an embodiment, the USO viewer (600) also contains an edit disabling means (606) for disabling the edit capabilities inherent in an application launched by the application launching means (602). In another embodiment, a verification means (608) verifies one or more of the digital signatures included in the universal signature object (100). In yet another embodiment, the verification means (608) checks a digital signature or the USO (100) against an archived copy. In an alternate embodiment, the USO viewer (600) includes a printing means (610) for printing information accessed or displayed by the viewer means (604).

In yet another aspect, a signing program (400) includes a key-accessing means (402), a key-verification means (404), transaction tracking means (406), and a universal-signature-object generating means (408). Key-accessing means (402) accesses the private (202) and public (204) keys of a signatory. Key-verification means (404) verifies the authenticity of the private and public key pair (202, 204). The USO generating means (408) generates a universal signature object (100) or appends a digital signature to an existing universal signature object (100). In another embodiment, the signing program (400) includes a timestamping means (410) for providing a timestamp of a digital signature. In yet another embodiment, the signing program (400) includes a transaction tracking means (406) for tracking a digital signature and/or a universal signature object (100).

### BRIEF DESCRIPTION OF THE DRAWINGS

FIG. 1 is a graphical depiction of a universal signature object.

FIG. 2 is a block diagram of an embodiment of a system capable of generating and utilizing a universal signature object.

FIG. 3 is a block diagram of a computer system capable of executing an application or applications, such as a signing program and a universal-signature-object viewer.

FIG. 4 is a functional block diagram of an embodiment of the signing program.

FIG. 5 is a flow diagram of an embodiment of a method utilized by the signing program to generate a universal signature object.

FIG. 6 is a functional block diagram of an embodiment of the universal-signature-object viewer.

FIG. 7 is a block diagram of an embodiment of a system capable of utilizing a universal signature object.

### DETAILED DESCRIPTION OF THE PREFERRED EMBODIMENTS

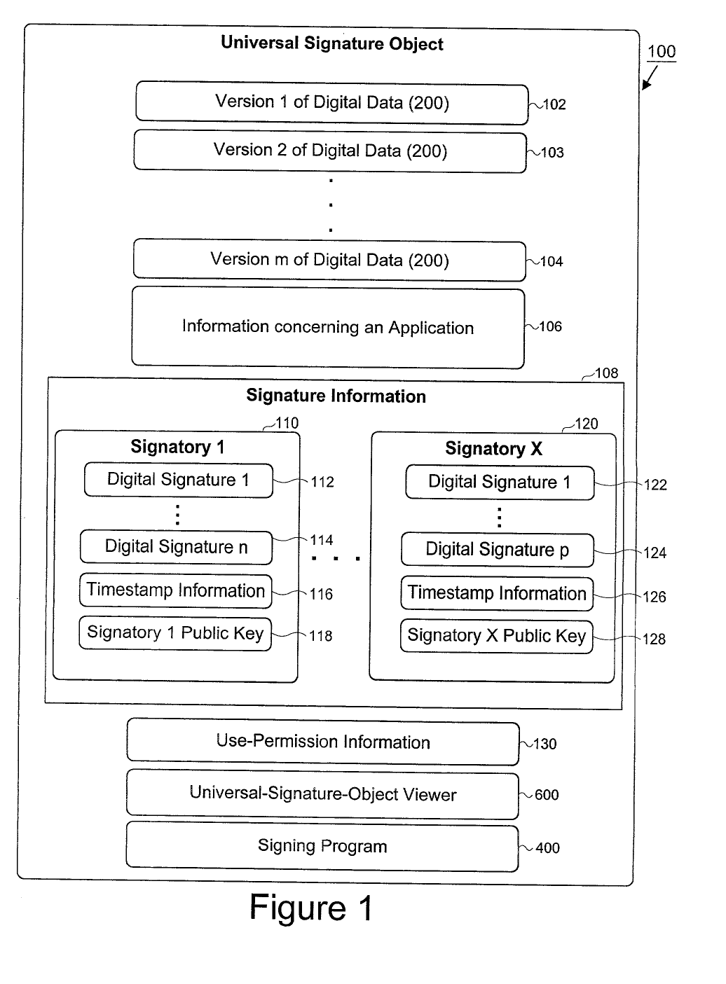

FIG. 1 shows a graphical depiction of a universal signature object 100. Universal signature object (USO) 100 binds digital data 200 to digital signature(s). The USO 100 comprises at least one version 102 of the digital data 200. Digital data 200 includes any digital information, such as a digital document or documents, digital graphics, digital audio, digital video, computer applications, email, and the like.

Universal signature object 100 can also contain a number of additional versions 103, 104 of the digital data 200. Each of the versions 102-104 has a file format. For example, if the digital data 200 is a business contract generated by a word processor, such as MS Word® by MicroSoft Corporation of Redmond, Wash., the first version 102 of the digital data 200 may be in a MS Word® file format. Another version 103 of the digital data 200 might be in a WordPerfect® file format compatible with the WordPerfect® word processor application by the Corel Corporation. Yet another version 104 might include the digital data 200 in a generic or cross-platform file format that can easily be ported between different applications. For example, the digital data 200 may be stored in version 104 as a text format or rich text format. Because version 104 has a file format that is compatible with multiple applications, the digital data 200 can be utilized by many word processor or text editor applications, including MS Word®, WordPerfect®, and Sun Microsystems' StarOffice™—to name just a few such applications.

The universal signature object 100 also contains information 106 concerning an application compatible with a file format of at least one of the versions 102-104. This information 106 could include identifying what application generated a version, what application or applications are compatible with a version, a pointer to the application, or an executable copy of an application compatible with a version. If the digital data 200 is an executable file, the information 106 can be a reference to one of the versions. That is, since the digital data is an application, it is its own compatible application.

The universal signature object 100 also contains signature information 108. The signature information 108 can be signature information of one signatory 110 or of multiple signatories 110-120. Using signature information 110 as representative of the other sets of signature information, signature information 110 contains a digital signature 112 of signature data. The signature data is a function of the digital data 200. For example, the signature data could be any of the versions 102-104 of the digital data 200, a hash of any of the versions 102-104, the universal signature object 100 itself (excluding the digital signature), or a hash of the universal signature object 100. The signature data could also include any combination of the foregoing examples of signature data. The signature data is functionally related to the data 200 in such a way that the digital signatures are effectively signatures of the digital data 200.

As depicted in FIG. 1, the signature information 110 can contain one 112 or more digital signatures 114. Furthermore, the different sets of signature information 110, 120 need not contain the same number of digital signatures. For example, the first signatory may only wish to include three digitals signatures, for example, a digital signature of a hash of version 102, a digital signature of version 104, and a digital signature of a hash of the universal signature object 100. An additional signatory many include only one digital signature 122, for example, a digital signature of a hash of the universal signature object 100. It shall be noted that by digitally signing the hash of the universal signature object 100, the additional signatory countersigns the previous signatures since the previous signatures are included as part of the universal signature object 100.

In one variant, the signature information 110 also contains timestamp information 116. The timestamp information can contain a separate timestamp for each signature 112-114 or for only some of the signatures 112-114. Alternatively, the timestamp information 116 could be a single timestamp for all of the signatures 112-114.

In another variant, the signature information 110 also contains information about the signatory's public key 118. This information 118 could a reference to where a third party can obtain the public key. Alternatively, the information 118 could be the signatory's public key or a digital certificate containing the signatory's public key 118. If the signatory utilized more than one public key to generate a digital signature, then each public key could be included along with information identifying which digital signatures were generated using which of the public keys.

In an embodiment, the universal signature object 100 also includes use-permission information 130. The use-permission information 130 indicates how a version or versions 102-104 of the digital data 200 can be utilized. For example, the use-permission information can indicate that a particular user may only have certain rights, such as read-only or view-only rights. Alternatively, the use-permission can give various users varied levels of access to a version 102-104 of the digital data 200. The universal-signature-object viewer 600, which will be explained in more detail below, utilizes this use-permission information.

In an embodiment, the universal signature object 100 also includes a universal-signature-object viewer (USO viewer) 600, which is an executable file that can utilize the universal signature object 100 to generate information from or related to the universal signature object 100. The universal-signature-object viewer will be described in more detail below.

In an embodiment, the universal signature object 100 also includes a signing program 400, which is an executable file used to generate a universal signature object 100 or to append a digital signature to an existing universal signature object 100. The signing program 400 will be described in more detail below.

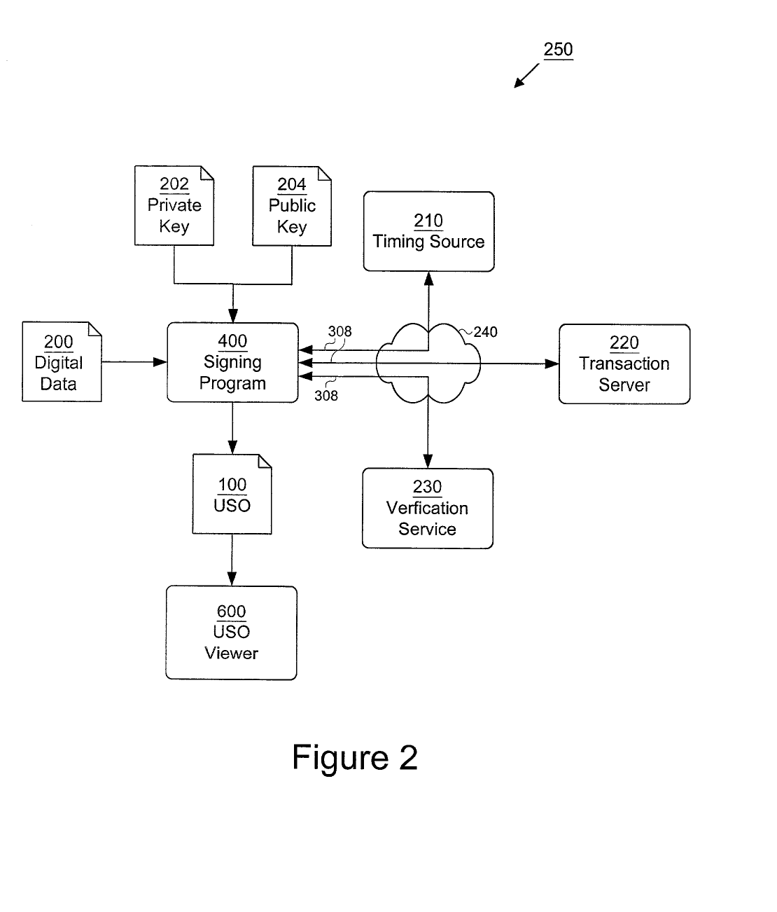

FIG. 2 depicts an embodiment of a system capable of generating and utilizing a universal signature object 100. FIG. 2 depicts a signing program 400 connected via a network connection 308 to a timing source 210, a transaction server 220, and a verification service 230. The network could be a local area network or a wide area network. In one embodiment, the signing program 400 connects to the timing source 210, the transaction server 220, and the verification service 230 via the Internet 240. In alternate embodiments, the timing source 210, the transaction server 220, and/or the verification service 230 reside on the same computer as the signing program 400 or within the same local area network. It shall also be noted that the timing source 210, the transaction server 220, and the verification service 230 can be different functions performed by a single entity.

FIG. 2 depicts a private key 202 and a corresponding public key 204 of a signatory accessible by the signing program 400. Also shown in FIG. 2, the digital data 200 is used by the signing program 400 in generating a universal signature object 100, which a USO viewer 600 utilizes to provide a user with information related to or derived from the universal signature object 100. The signing program 400 can be executed on a computer system, such as a personal computer or workstation.

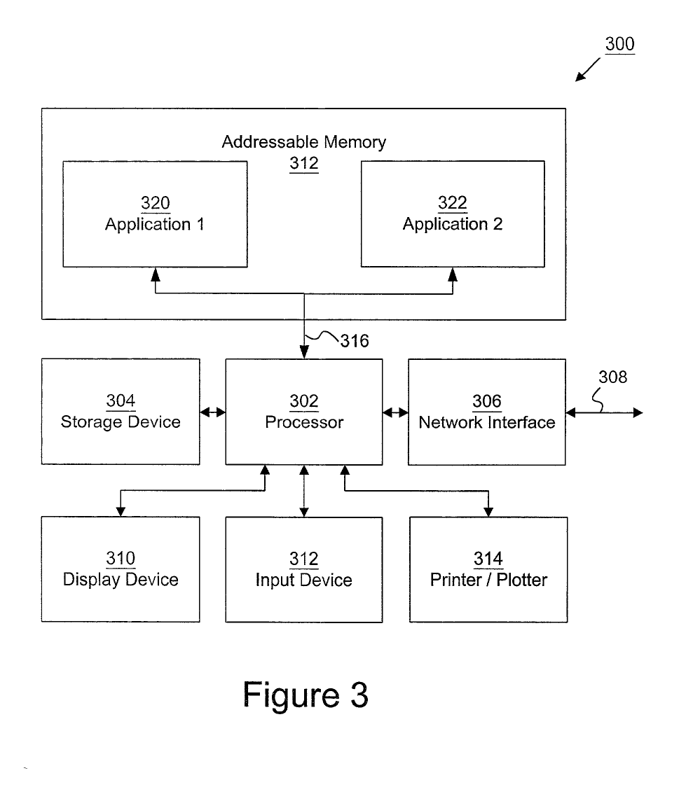

FIG. 3 illustrates a computer system 300 wherein a processor 302 executes software instructions and interacts with other system components. A storage device 304 coupled to the processor 302 provided long-term storage of data and software programs and may be implemented as a hard disk drive or other suitable mass storage devices. A network interface 306 coupled to the processor 302 connects 308 the computer system to a network. A display device 310 coupled to the processor 302 displays text and graphics under the control of the processor 302. An input device 312, such as a mouse and or keyboard, is coupled to the processor 302 and facilitates user control of the system 300. An addressable memory 312 coupled to the processor 302 stores software instructions 320, 322 to be executed by the processor 302 and is implemented using a combination of standard memory devices such as random access memory (“RAM”) and read only memory (“ROM”) devices. In one embodiment, the memory 312 stores a number of software objects or modules, for example, a first application 320 and a second application 322. The applications 320, 322, individually or collectively, could represent the signing program 400 and the USO viewer 600.

Throughout this discussion, modules or means are described as separate functional units. This is done for clarity of explanation. In different implementations, various means or modules may be combined and integrated into a single software application or device. Alternatively, various means or modules may be distributed into several software applications or devices. The modules or means can also be implemented in software, hardware, firmware, or any combination thereof.

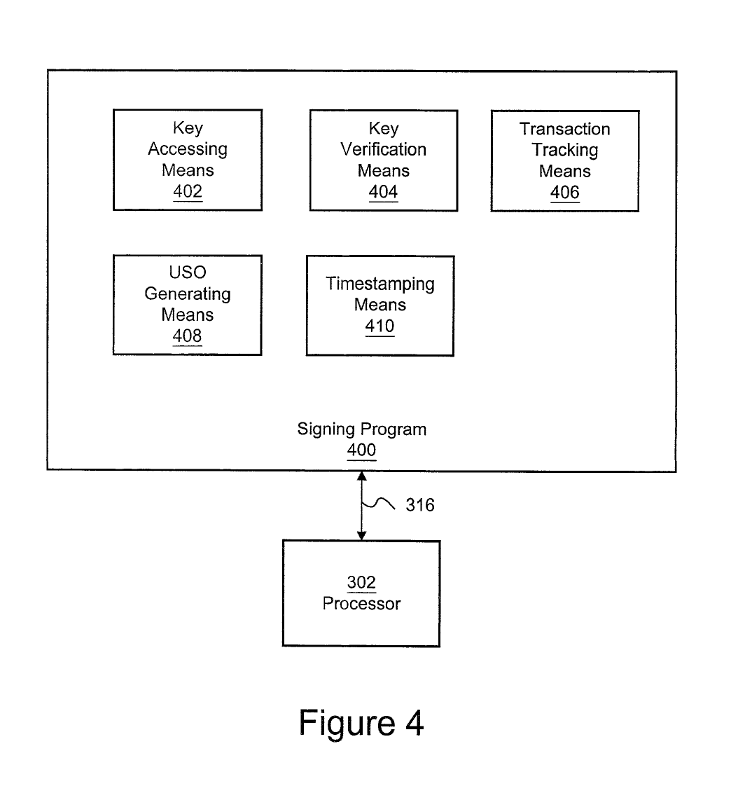

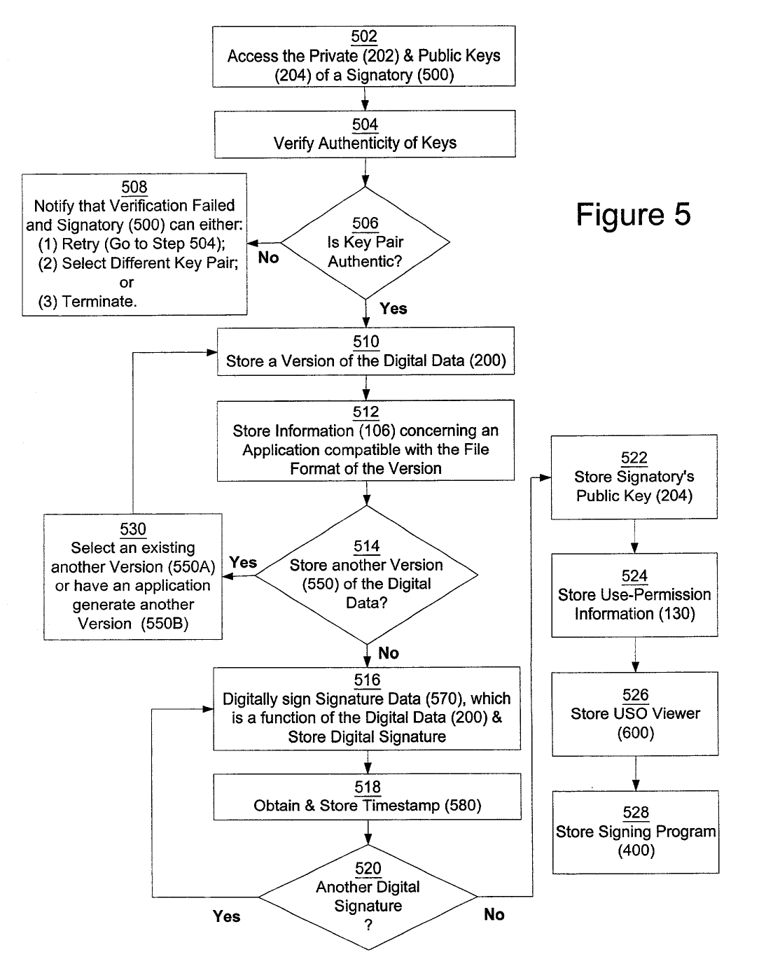

FIG. 4 represents an embodiment of the signing program 400, which could be an application 320, 322 operating on system 300. Signing program 400 comprises a key-accessing means 402, a key-verification means 404, transaction tracking means 406, a universal-signature-object generating means 408, and a timestamping means 410. These means or modules in the signing program 400 interface with the processor 302 as represented by arrow 316. Key-accessing means 402 accesses the private 202 and public 204 keys of a signatory. Key-verification means 404 verifies the authenticity of the private and public key pair 202, 204 (respectively). The USO generating means 408 generates a universal signature object 100 or appends a digital signature to an existing universal signature object 100. The generation of the universal signature object 100 will be described in more detail with respect to FIG. 5. The transaction tracking means 406 interacts with a transaction server in order to provide an audit trail or to archive a digital signature or a USO 100.

FIG. 5 depicts an embodiment of a method for generating a universal signature object 100 as part of the system depicted in FIG. 2. The key-accessing means 402 of the signing program 400 accesses 502 the private 202 and public 204 keys of a signatory 500. The signatory 500 can supply the private-public key pair 202, 204 to the signing program 400 in a number of ways. In one embodiment, the private and public key pair 202, 204 is stored on the storage device 304 and accessed by the signing program 400 through the processor 302. Alternatively, the key pair is stored on a network and accessed through the network interface 306. In yet another embodiment, the signatory 500 inputs the private and public key pair 202, 204 (respectively) through the input device 312.

The key-verification means 404 verifies 504 the authenticity of the accessed private and public key pair 202, 204 (respectively). As depicted in FIG. 2, the signing program 400, which contains the key-verification means 404, could access a verification service 230 via network connection 308. The verification service 230 could be a public key depository, a certificate depository, a certificate or key pair generator, or certificate authority. Verification can be achieved by authenticating the private key. In one embodiment, the key-verification means 404 encrypts a string of data, random or meaningful, using the private key 202 and sends it together with the unencrypted string of data to the verification service 230. The verification service 230 uses the latest published certificate of the signatory 500 to decrypt the encrypted string of data and compares it with the original string. If they match, then the private key 202 is authentic. In another embodiment, the key-verification means 404 obtains the latest certificate of the signatory 500 from the verification service 230 and determines if it matches with the public key 204. If it matches, the private key 202 is authentic. The key-verification means 404 may optionally choose to verify the verification service 230 before trusting the public certificate it returned. Alternatively, the signatory 500 could self-certify and thus provide the verification to the signing program 400. In this embodiment, the signatory 500 is also the issuer of the certificate and the key pair 202, 204, and acts as the verification service 230 to verify the authenticity of the keys to the signing program.

If the keys 202, 204 are not authentic 506, the signing program 400 alerts the signatory 500 that he can either: (1) retry the process; (2) select or provide a different key pair to the signing program 400; or (3) terminate use of the signing program 400. The key pair 202, 204 may fail to be authenticated for several reasons. For example, the keys may have expired or been revoked. They may have also been mis-entered or otherwise incorrectly supplied by the signatory 500. In any of the foregoing events, if the keys are not valid and/or are not the signatory's keys, the signing program 400 will not use them to generate a digital signature.

Assuming the keys 202, 204 are properly authenticated, the signing program's 400 universal-signature-object generating means 408 creates a universal signature object by storing 510 a version of the digital data 200. The digital data 200 may be data of any type, such as a text document, an executable file, or any other file. Referring to the example used in connection with the description of the USO 100 in FIG. 1, the data may be a business contract generated by Microsoft Word®. The version 102 stored 510 in the USO will have a Microsoft Word® format. The signing program records 512 that the version 112 format is compatible with Microsoft Word®. Alternatively, the signing program 400 searches the computer system 300 on which the signing program 400 operates or searches a network connected to the computer system 300 via a network connection 308 to legally obtain a copy of Word® and include it as part of the information 106 concerning the application.

The signing program's 400 universal-signature-object generating means 408 prompts the signatory if he would like to store 514 an alternate version 550 of the digital data 200. The signatory can select 530 an existing, but different, version 550A of that data 200 or have an application generate another version of the data 550B. Alternatively, the generating means 408 may automatically produce alternate versions 550 without prompting. In one embodiment, the signing program 400 launches an application that the signatory uses to convert the data 200 into another format. In another embodiment, the signing program includes the ability to convert between multiple file formats. In yet another embodiment, the signatory 500 provides the alternate version 550 or uses an application to create an alternate version 550. Continuing with the business document example, the first version 102 of the business contract was stored as a Microsoft Word® document file. The signatory selects or generates 530 the data 200 in a different format, such as a WordPerfect® format. That version 550 is stored 510 in the USO. Because the signing program has associated at least one application (Microsoft Word®) compatible with at least one of the version (the first version 102), the step of including 512 information 106 about an application compatible with the version 550 may optionally be excluded. The process of including versions (steps 510, 512, 514, 530) continues until the signatory wishes 514 to include no additional versions of the digital data 200. For the purposes of the continuing business contract illustration, assume the signatory stores a third version 104 of the business contract in a rich text format.

It is beneficial to have alternate versions of the digital data 200. An alternate version, particularly a version that is compatible with more than one application, such as the third version (rich text format) of the business contract example, increases the value and longevity of the USO 100. More individuals and businesses can access the data 200 and can access it for a longer period of time because there is less reliance on a single, specific format. Furthermore, this portability of the data among multiple applications provides for better archiving. If in the future a person or business needs to verify the digital data 200 (along with a digital signature or signatures), having the data 200 in multiple versions or in a portable/generic format increases the chances that an application can be located to access the data 200. Thus, if an application that generated a version (i.e., the native application), ceases to exist, one of the alternate versions most likely can be utilized.

It may also be beneficial to have alternate versions if a third party who will utilize the universal signature object 100 may only accept certain formats. Using business contract example, the signatory may use Microsoft Word®, but the party it is contracting with may use only StarOffice™. The parties can utilize the USO as a means for transaction by providing different format versions of the data 200. Each party can utilize the data 200 without incompatibility problems, and each party can include its signature to the agreement (as will be explained in more detail below).

When the signatory finishes storing versions of the digital data 220, the signing program 400 creates 516 a digital signature. The USO generating means 408 generates 516 a digital signature of signature data 570 using the signatory's private key 202. The signature data 570 is data that is a function of the digital data 200. For example, the signature data could be any one of the versions of the digital data 200, a hash of any one of the versions, the universal signature object 100, or a hash of the universal signature object 100. The signature data 570 could also include any combination of the foregoing examples. Because of the functional relation between the signature data 570 and the digital data 200, any digital signature is effectively a digital signature of the digital data 200.

In an embodiment, the timestamping means 410 in the signing program 400 requests 518 a timestamp 580 from a timing source 210 for the digital signature. The timestamp is stored as part of the timestamp information 116, 126 of the USO 100. In one embodiment, the timing source 210 is a third-party timing source accessed through a network connection 308, as depicted in FIG. 2. Alternatively, the signatory's computer 300, or a timing source 210 connected to the computer system 300 through a local area network connection, acts as the timing source 210. Alternatively, for greater accuracy, the timestamping means 410 obtains 518 timing information or timestamps from multiple time sources. In each of the foregoing timestamp embodiments, the timing source 210 can also digitally sign the timestamp.

With the digital signature and timestamp (if a timestamp is obtained) stored in the USO 100, the signing program 400 prompts 520 the signatory 500 to determine whether the signatory wishes to append an additional digital signature. If the signatory 500 wishes to include an additional digital signature, step 516 and optional step 518 are repeated. The additional digital signature can be of different signature data than was used in the previous digital signature. It shall be noted that the USO 100 and the hash of the USO, which each can serve as signature data, can be different than for the previous digital signature because the USO 100 includes the previous digital signature. When the signatory 500 no longer desires 520 to include an additional digital signature, the universal signature object generation is complete.

In an alternative embodiment, the signing program 400 includes a transaction tracking means 406, wherein the transaction tracking means 406 obtains, from a transaction server 220, a tracking number for audit purposes. In yet another embodiment, the transaction tracking means 406 transmits to the transaction server 220 a copy of the universal signature object 100 or a copy of a digital signature and timestamp. The transaction server 220 can store the universal signature object 100 or the digital signature for archiving, audit, and/or verification purposes.

In an embodiment, the USO generating means 408 includes 522 the signatory 500's public key 204. Including the public key 204 is beneficial because it simplifies the digital signature verification process. Verification is simplified because a person or entity trying to verify a digital signature does not need to search for the signatory's public key. Including the public key 202 in the USO 100 also makes the USO 100 a self-contained item and better suited for archiving.

In an embodiment, the USO generating means 408 includes 524 use-permission information 130. The USO generating means 408 prompts the signatory 500 to provide certain levels of use permission with respect to one or more of the versions of the digital data and/or use permission for the universal signature object 100. Using the business contract illustration, the signatory 500 may indicate that each of the versions are read-only, so that other users or recipients of the USO 100 may only view the data 200 but not edit it. Alternatively, the signatory 500 may allow for editing of some versions by certain signatories or users of the USO but not by others.

In an embodiment, the USO generating means 408 includes a universal-signature-object viewer 600. Including the USO viewer 600 in the USO 100 makes the USO 100 further self-contained because the USO viewer 600 is designed to utilize a USO 100. Thus, a third party need not search for one application to utilize a version of the digital data 200 in the USO 100, a second application to view a digital signature, and a third application to verify the digital signature. The USO viewer is described in more detail below.

In an embodiment, the USO generating means 408 includes the signing program 400 as part of the universal signature object 100. Including the signing program 400 is beneficial because the universal signature object 100 may be transmitted or passed to additional signatories. Providing the signing program 400 with the USO 100 simplifies the process of appending signatures. In one embodiment, the process of appending a digital signature is similar to the process described for generating a USO 100. It shall be noted, however, that appending a digital signature may only require a subset of the method depicted in FIG. 5. For example, steps 510, 512, and 514 may be removed from the process of appending a digital signature to an existing USO 100. It shall also be noted that the method depicted in FIG. 5 is merely one embodiment.

In an embodiment, the signing program 400 compresses the USO. Alternatively, the signing program 400 encrypts the USO, for example, with a USO recipient's public key or a session key. In another embodiment, the signing program 400 interfaces with a routing service to route the USO 100 to the next recipient. The routing service may optionally return the next recipient's public key, wherein the signing program 400 encrypts the USO 100 with the recipient's public key and transmits the USO 100 via the network connection 308 directly to the recipient, transmit it via a email service, or transmit it via the routing server. Embodiments of the routing methods and systems are described in commonly-assigned U.S. Provisional Patent Application Serial No. 60/242,013, “Efficient Method For Routing Deliveries Through Recipient Translation,” by Eng-Whatt Toh, filed Oct. 19, 2000. The subject matter of the foregoing application is incorporated herein by reference in its entirety. In another embodiment, the signing program both compresses and encrypts the USO 100.

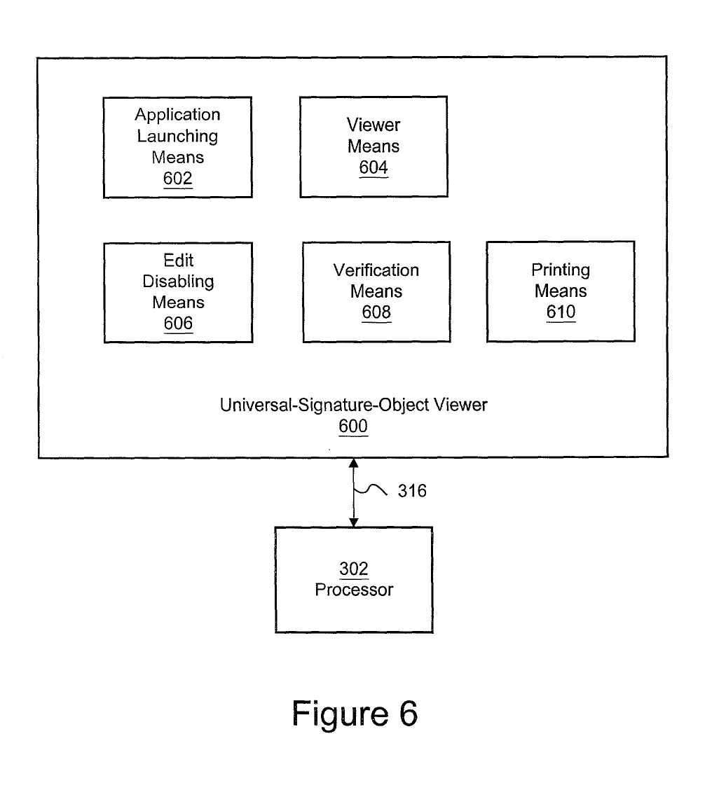

Referring now to FIG. 6, an embodiment of a universal-signature-object viewer 600 is depicted. As with the signing program 400, the USO viewer 600 functions on a computer system 300 and could be represented in FIG. 3 as either application 320 or 322. The USO viewer 600 includes an application launching means 602, a viewer means 604, an edit disabling means 606, a verification means 608, and a printing means 610. The application launching means 602 launches an application compatible with a file format of a version of the digital data 200. A viewer means 604 generates information concerning the universal signature object 100 for display to a user of a USO 100. The information concerning the universal signature object 100 could include, for example, a list of items contained within the universal signature object, such as each of the versions of the digital data 200, the number of signatories, the names of each of the signatories, the timestamp information, whether or not public keys have provided for each of the signatories, the use-permission information, whether a USO viewer 600 has been included with the USO 100, and/or whether a signing program 400 has been included with USO 100. The viewer means can also provide for display of a digital signature's verification results. In an embodiment, the viewer means 604 could be a word processor or a graphical display to display any and all of the aforementioned information concerning the USO 100.

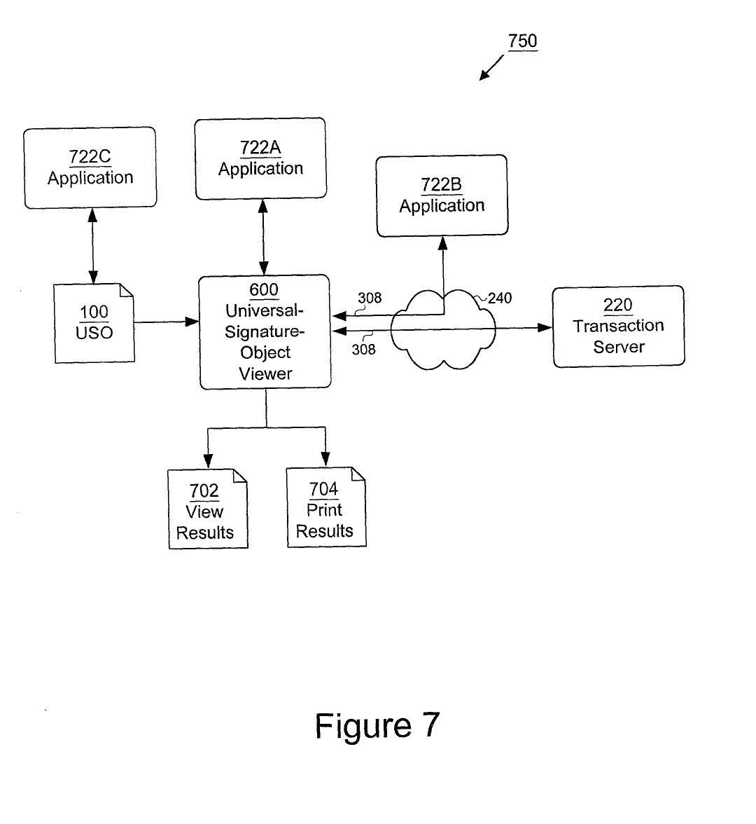

The application launching means 602 uses the information 106 concerning an application compatible with a version of the digital data to find and launch an application compatible with the version. As depicted in FIG. 7, the application launching means may search the computer system 300 on which it operates to locate an application 722A compatible with one of the versions. Alternatively, the application launching means 602 may search a network via network connection 308 for an application 722B compatible with one of the versions. In yet another embodiment, the universal signature object 100 contains, as part of the information 106 concerning an application compatible with a version of the digital data, an executable version of an application 722C capable of utilizing one of the versions of the digital data 200. If a version of the digital data 200 is, itself, an executable file, the application launching means 602 launches one of the versions of the data 200 from the USO 100. In one embodiment, the application 722A, 722B, or 722C is embedded within an integrated user interface of the universal-signature-object viewer 600 or is otherwise under the control of the universal-signature-object viewer 600. In another embodiment, the application 722A, 722B, or 722C is launched in separate user interface windows. If the format of a version, or formats of all of the versions, are unrecognizable or unknown to the signing program 400 when generating the USO 100, the USO 100 includes that the formats are unknown in the information 106 concerning an application compatible with a version of the digital data 106. The USO viewer 600, reading that the file formats are unknown, so notifies the user.

In an embodiment, the USO viewer 600 contains an edit disabling means 606 wherein the application launching means 602 launches an application and disables edit capabilities inherent in that application. In one embodiment, the edit disabling means is always utilized. In another embodiment, the application launching means 602 checks the use-permission to determine if the edit disabling means 606 should be employed. Continuing the business contract example, if the signatory 500 does not want any subsequent users of the USO 100 to edit the MS Word® version of the digital data (the first version of the data 200), when a subsequent user access the version, the application launching means 602 does not enable the edit functionality of MS Word® when it launches the application. Thus, the editing capabilities have been disabled and the document cannot be edited. This functionality can be applied to other version of the digital data 200 as well.

In an embodiment, a verification means 608 verifies one or more of the digital signatures included in the universal signature object 100. In one embodiment, the verification means 608 uses the public key 204 of the signatory 500 to verify the digital signature. If the verification matches, that information will be provided through the viewer means 604 to the USO viewer user or also provided through the printing means 610, which will be described in more detail below. If the verification does not match, that information will likewise be provided to the user. If the public key was not provided with the universal signature object 100, the verification means can, through the computer system 300, search for and obtain a copy of the public key. For example, the verification service 230 or a public key directory can provide the public key to the verification means 608 via the network connection 308. Alternatively the verification service 230 can be used to provide the latest public key 204 of the signatory 500 regardless of whether one was included in the universal signature object 100.

In yet another embodiment, the verification means 608 also checks a digital signature or the USO 100 against an archived copy stored at a transaction server 220. The verification means 608 accesses the archived copy by interfacing, through the network interface 306 and network connection 308, to the transaction server 220 that contains an archived copy of the digital signature and/or universal signature object 100. This second verification provides added security and assurances that the digital signature and/or the USO 100 have not been tampered with and are accurate.

In an embodiment, the USO viewer 600 includes a printing means 610. The printing means 610 prints any of the information accessed or displayed by the viewer means 604 as described previously. In an alternate embodiment, the printing means 610 can print a version of the digital data 200 or interface with an application and provide print versions through the use of that application. In another other embodiment, the printing means 610 digitally watermarks the print copies generated by it.

From the above description, it will be apparent that the invention disclosed herein provides a novel and advantageous systems and methods of binding one or more digital signatures to digital data, regardless of the file format of the versions of the digital data 200. The above description is included to illustrate the preferred embodiments and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A computer-readable medium storing a universal signature object for binding a digital signature to digital data, the universal signature object comprising:
at least one version of the digital data, wherein each version has a file format;
a digital signature of signature data, wherein the signature data is a function of the digital data; and
information concerning an application compatible with the file format of at least one of the versions.

2. The universal signature object of claim 1 wherein the file format of at least one version is a native file format of the digital data.

3. The universal signature object of claim 1 wherein the file format of at least one version is compatible with more than one application.

4. The universal signature object of claim 1 wherein the file format of at least one version is an alternate file format.

5. The universal signature object of claim 4 wherein the information concerning an application compatible with the file format of at least one of the versions includes information concerning an alternate application compatible with the alternate file format.

6. The universal signature object of claim 5 wherein the information concerning the alternate application includes an embedded executable file of the alternate application.

7. The universal signature object of claim 4 wherein the signature data is selected from the group comprising:
one of the versions of the digital data;
the universal signature object, prior to inclusion of the digital signature;
a hash of one of the versions of the digital data; and
a hash of the universal signature object, prior to inclusion of the digital signature.

8. The universal signature object of claim 4 wherein the digital signature is timestamped.

9. The universal signature object of claim 4 further comprising:
a public key, corresponding to a private key used to generate the digital signature.

10. The universal signature object of claim 4 further comprising an additional digital signature by an additional signatory of additional signature data, wherein the additional signature data is a function of the digital data.

11. The universal signature object of claim 10 wherein the additional signature data is selected from the group comprising:
one of the versions of the digital data;
the universal signature object, prior to inclusion of the additional digital signature;
a hash of one of the versions of the digital data; and
a hash of the universal signature object, prior to inclusion of the additional digital signature.

12. The universal signature object of claim 10 wherein the additional digital signature is timestamped.

13. The universal signature object of claim 1 wherein the signature data is selected from the group comprising:
one of the versions of the digital data;
the universal signature object, prior to inclusion of the digital signature;
a hash of one of the versions of the digital data; and
a hash of the universal signature object, prior to inclusion of the digital signature.

14. The universal signature object of claim 1 wherein the information concerning an application compatible with the file format of at least one of the versions includes information identifying the application compatible with the file format of at least one of the versions.

15. The universal signature object of claim 1 wherein the information concerning an application compatible with the file format of at least one of the versions includes an executable file of the application compatible with the file format of at least one of the versions.

16. The universal signature object of claim 1 wherein the digital signature is timestamped.

17. The universal signature object of claim 1 further comprising:
a public key, corresponding to a private key used to generate the digital signature.

18. The universal signature object of claim 1 further comprising an additional digital signature by an additional signatory of additional signature data, wherein the additional signature data is a function of the digital data.

19. The universal signature object of claim 18 wherein the additional signature data is selected from the group comprising:
one of the versions of the digital data;
the universal signature object, prior to inclusion of the additional digital signature;
a hash of one of the versions of the digital data; and
a hash of the universal signature object, prior to inclusion of the additional digital signature.

20. The universal signature object of claim 18 wherein the additional digital signature is timestamped.

21. The universal signature object of claim 18 further comprising:
a public key corresponding to the private key used to generate the additional digital signature.

22. The universal signature object of claim 1 further comprising:
use-permission information regarding permitted use of the universal signature object.

23. The universal signature object of claim 1 wherein the universal signature object is compressed.

24. The universal signature object of claim 1 wherein the universal signature object is encrypted.

25. The universal signature object of claim 1 further comprising:
a universal-signature-object viewer for utilizing the universal signature object.

26. The universal signature object of claim 25 wherein the universal-signature-object viewer for utilizing the universal signature object comprises:
an application launching means for launching the application compatible with the file format of at least one of the versions; and
a viewer means for displaying information concerning the universal signature object.

27. The universal signature object of claim 1 further comprising:
a signing program for modifying the universal signature object to include an additional digital signature.

28. The universal signature object of claim 1 wherein the application compatible with the file format of at least one of the versions includes said version.

29. A universal-signature-object viewer for utilizing a universal signature object comprising at least one version of digital data, wherein each version has a file format; a digital signature of signature data, wherein the signature data is a function of the digital data; and information concerning an application compatible with the file format of at least one of the versions, the universal-signature-object viewer comprising:
an application launching means for launching the application compatible with the file format of at least one of the versions; and
a viewer means for displaying information concerning the universal signature object.

30. The universal-signature-object viewer of claim 29 wherein the information concerning the universal signature object displayed by the viewer means comprises at least one data field from the group of data fields comprising:
use-permission information regarding permitted use of the universal signature object;
a list of items contained within the universal signature object;
at least one version of the digital data;
a digital signature;
a name of a signatory of the digital signature;
a timestamp of the digital signature; and
digital signature verification results.

31. The universal-signature-object viewer of claim 29 further comprising:
an edit disabling means for disabling editing capabilities of the application.

32. The universal-signature-object viewer of claim 29 wherein the application launching means searches a computer system on which the universal-signature-object viewer operates to locate the application compatible with the file format of at least one of the versions.

33. The universal-signature-object viewer of claim 29 wherein the information concerning an application compatible with the file format of at least one of the versions comprises an executable file of the application compatible with the file format of at least one of the versions.

34. The universal-signature-object viewer of claim 29 wherein the application compatible with the file format of at least one of the versions operates under the control of the universal-signature-object viewer.

35. The universal-signature-object viewer of claim 29 further comprising:
a verification means for verifying the digital signature.

36. The universal-signature-object viewer of claim 35 wherein the verification means verifies the digital signature against an archived copy of the digital signature obtained from a transaction server.

37. The universal-signature-object viewer of claim 29 further comprising:
a printing means for providing a print copy of information concerning the universal signature object.

38. The universal-signature-object viewer of claim 37 wherein the information concerning the universal signature object comprises at least one data field selected from the group of data fields comprising:
use-permission regarding permitted use of the universal signature object;
a list of items contained within the universal signature object;
at least one version of the digital data;
a digital signature;
a name of a signatory of the digital signature;
a timestamp of the digital signature; and
digital signature verification results.

39. The universal-signature-object viewer of claim 37 wherein the print means digitally watermarks the print copy.

40. The universal-signature-object viewer of claim 29 wherein:
the universal signature object further comprises at least one additional digital signature;
the digital signatures are timestamped; and
the viewer means displays the digital signature in timestamp order.

41. The universal-signature-object viewer of claim 29 wherein the universal-signature-object viewer operates within a browser application.

42. The universal-signature-object viewer of claim 29 wherein the universal-signature-object viewer is incorporated into the universal signature object.

43. The universal-signature-object viewer of claim 42 wherein the universal signature object is a standalone application.

44. The universal-signature-object viewer of claim 29 wherein the universal-signature-object viewer is a network application accessible via a network connection.

45. A method for digitally signing digital data, comprising:
accessing a signatory's private-public key pair;
authenticating the private-public key pair; and
in response to a universal signature object of the digital data not existing:
using the signatory's private key to generate a digital signature of signature data, wherein the signature data is a function of the digital data; and
generating the universal signature object of the digital data, the universal signature object comprising:
at least one version of the digital data, wherein each version has a file format;
the digital signature; and
information concerning an application compatible with the file format of at least one of the versions.

46. The method of claim 45 wherein the signature data is selected from the group comprising:
one of the versions of the digital data;
the universal signature object, prior to inclusion of the digital signature;
a hash of one of the versions of the digital data; and
a hash of the universal signature object, prior to inclusion of the digital signature.

47. The method of claim 45 wherein the universal signature object further comprises:
a timestamp of the digital signature.

48. The method of claim 47 wherein the signatory verifies the authenticity of the private-public key pair and provides the timestamp.

49. The method of claim 45 further comprising the steps of:
requesting a tracking number from a transaction server; and
transmitting at least a copy of the digital signature to the transaction server.

50. The method of claim 45 wherein at least one of the versions of the digital data has a non-native file format.

51. The method of claim 45 wherein the universal signature object further comprises:
the signatory's public key.

52. The method of claim 45 wherein the universal signature object farther comprises:
use-permission information regarding the use of the universal signature object.

53. The method of claim 45 wherein the universal signature object further comprises:
a universal-signature-object viewer for utilizing the universal signature object.

54. The method of claim 53 wherein the universal-signature-object viewer for utilizing the universal signature object comprises:
an application launching means for launching the application compatible with the file format of at least one of the versions; and
a viewer means for displaying information concerning the universal signature object.

55. The method of claim 45 wherein the universal signature object further comprises:
a signing program for modifying the universal signature object to include an additional digital signature.

56. The method of claim 45 further comprising the step of:
in response to the universal signature object of the digital data existing:
using the signatory's private key to generate a digital signature of signature data, wherein the signature data is a function of the digital data; and
modifying the universal signature object to include an additional digital signature.

57. The method of claim 56 wherein the signature data is selected from the group comprising:
one of the versions of the digital data;
the universal signature object, prior to inclusion of the digital signature;
a hash of one of the versions of the digital data; and
a hash of the universal signature object, prior to inclusion of the digital signature.

58. The method of claim 57 wherein the universal signature object further comprises:
a timestamp of the digital signature.

59. The method of claim 57 further comprising the steps of:
requesting a tracking number from a transaction server; and
transmitting at least a copy of the digital signature to the transaction server.

60. The method of claim 57 wherein the universal signature object further comprises:
the signatory's public key.

61. A signing program for binding a digital signature to digital data, the signing program comprising:
a key-accessing means for accessing a signatory's private-public key pair;
a key-verification means for authenticating the private-public key pair;
a universal-signature-object generating means for, in response to a universal signature object of the digital data not existing:
using the signatory's private key to generate a digital signature of signature data, wherein the signature data is a function of the digital data; and
generating the universal signature object of the digital data, the universal signature object comprising:
at least one version of the digital data, wherein each version has a file format;
the digital signature; and
information concerning an application compatible with the file format of at least one of the versions.

62. The signing program of claim 61 wherein the signature data is selected from the group comprising:
one of the versions of the digital data;
the universal signature object, prior to inclusion of the digital signature;
a hash of one of the versions of the digital data; and
a hash of the universal signature object, prior to inclusion of the digital signature.

63. The signing program of claim 61 wherein the universal signature object further comprises:
a timestamp of the digital signature.

64. The signing program of claim 61 further comprising:
a transaction tracking means for requesting a tracking number from a transaction server.

65. The signing program of claim 64 wherein the transaction tracking means transmits the digital signature to the transaction server.

66. The signing program of claim 61 wherein at least one of the versions of the digital data has a non-native file format.

67. The signing program of claim 61 wherein the universal signature object further comprises:
the signatory's public key.

68. The signing program of claim 61 wherein the universal signature object further comprises:
use-permission information regarding the use of the universal signature object.

69. The signing program of claim 61 wherein the universal signature object further comprises:
a universal-signature-object viewer for utilizing the universal signature object.

70. The signing program of claim 69 wherein the universal-signature-object viewer for utilizing the universal signature object comprises:
an application launching means for launching the application compatible with the file format of at least one of the versions; and
a viewer means for displaying information concerning the universal signature object.

71. The signing program of claim 61 wherein the universal signature object further comprises:
a signing program for modifying the universal signature object to include an additional digital signature.

72. The signing program of claim 61 wherein the universal-signature-object generating means further performs the step of:
in response to the universal signature object of the digital data existing:
using the signatory's private key to generate a digital signature of signature data, wherein the signature data is a function of the digital data; and
modifying the universal signature object to include an additional signature.

73. The signing program of claim 72 wherein the signature data is selected from the group comprising:
one of the versions of the digital data;
the universal signature object, prior to inclusion of the digital signature;
a hash of one of the versions of the digital data; and
a hash of the universal signature object, prior to inclusion of the digital signature.

74. The signing program of claim 72 wherein the universal signature object further comprises:
a timestamp of the digital signature.

75. The signing program of claim 72 further comprising:
a transaction tracking means for requesting a tracking number from a transaction server.

76. The signing program of claim 75 wherein the transaction tracking means transmits the digital signature to the transaction server.

77. The signing program of claim 61 wherein the signing program is integrated with a primary application to provide digital signing capability for the files utilized by the primary application.

78. The signing program of claim 61 wherein the signing program operates within a browser application.

79. The signing program of claim 61 wherein the signing program is a standalone application.
